(19) United States
(12) Patent Application Publication
(10) Pub. No.: US 2026/0269967 A1
(43) Pub. Date: Sep. 10, 2026

(54) METHOD AND DEVICE FOR MASTER-SLAVE CLOCK SYNCHRONIZATION CALIBRATION

(71) Applicant: Nanning FuLian FuGui Precision Industrial Co., Ltd., Nanning (CN)

(72) Inventors: SHENG-XIONG WEI, Nanning (CN); Quan-Lin Wu, Nanning (CN); Kai-si Long, Nanning (CN)

(21) Appl. No.: 19/172,905

(22) Filed: Apr. 8, 2025

(30) Foreign Application Priority Data
Mar. 4, 2025 (CN) 202510252082.7

(51) Int. Cl. H04J 3/06

(52) U.S. Cl. CPC H04J 3/0667

(57) ABSTRACT

A method and device for master-slave clock synchronization calibration, comprising a processor configured to estimate the initial error square between the master clock data and the slave clock data. Based on the sum of the initial error square and the noise variance, a predicted deviation at a first time point is estimated. A gain parameter is estimated based on the ratio of the predicted deviation and the sum of the predicted deviation and the anomalous variable. Weighting the difference between the initial deviation and the predicted deviation using the gain parameter, and adding the initial deviation to estimate a time deviation. The time deviation is used to calibrate the slave clock data at the first time point.

### FIELD

The subject matter herein generally relates to a field of network communication technology, particularly a method and device for master-slave clock synchronization calibration.

### BACKGROUND

Precision Time Protocol (PTP) is a protocol for high-precision clock synchronization using network communication technology. The protocol measures and adjusts the synchronization error between clocks by exchanging event messages and their timestamps between the master clock and slave clock devices. Through the open-source software Precision Time Protocol Daemon (PTPd), the protocol can calculate the path delay and time offset between the master and slave clocks and adjust them accordingly, achieving precise synchronization of both time and frequency between the clocks.

Before performing clock calibration in PTP, it is necessary to select a master clock with precise time. Currently, the Best Master Clock Algorithm (BMCA) is commonly used to select the master clock.

Please refer to FIG. 1. After selecting the master clock, the following process can be used to synchronize the time between the master clock and the slave clock:
1. A master-slave relationship is established between the clocks of two nodes, a master node sends the starting time t₁ to a slave node;
2. The slave node records the time t₂ when it receives the message from the master clock;
3. The slave node sends a reply message to the master node and records the master clock's time t₃;
4. The master node receives the reply message and then sends back its time t₄ to the slave node;
5. The slave node can calculate the deviation between its clock and the master clock using the following formula to complete the calibration of the slave clock:

$$offset = \frac{( {t}_{2} - {t}_{1} ) - ( {t}_{4} - {t}_{3} )}{2} .$$

However, when selecting the master clock using BMCA, multiple communications and competition among devices in the network are required, making the process complex and uncertain regarding the stability of the master clock. Additionally, the precision of time synchronization using PTP can be easily affected by the network environment. In situations where network delays are large or unstable, the accuracy of time synchronization decreases, which affects the synchronization result.

Therefore, there is a need for a master-slave time synchronization calibration method and device that can select the most precise master clock and accurately predict the required calibration magnitude, thereby improving synchronization, stability, and precision.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a prior art of a time synchronization process of a PTP protocol.

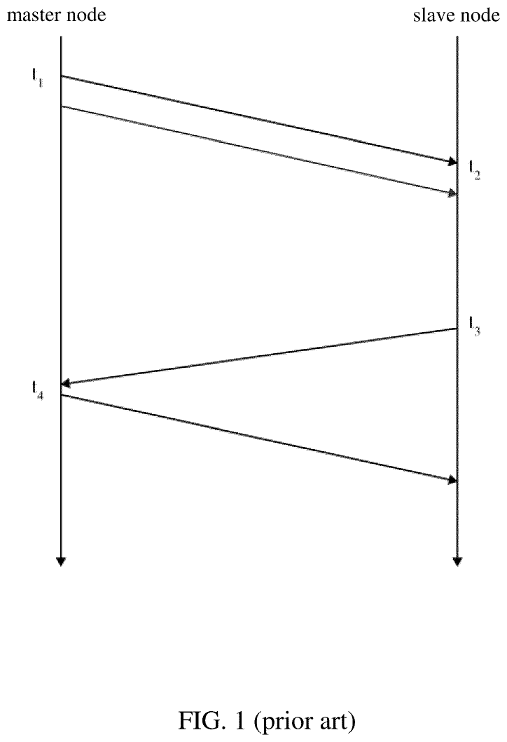

FIG. 2 is a schematic diagram of a first embodiment of a device for master-slave clock synchronization calibration.

FIG. 3 is a flowchart of a first embodiment of a method to select the master clock.

FIG. 4 is a schematic diagram of a second embodiment of a device for master-slave clock synchronization calibration.

FIG. 5 is a flowchart of an embodiment of a method to calibrate a master-slave clock synchronization.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to;” it specifically indicates open-ended inclusion or membership in the so-described combination, group, series, and the like.

A method and device for master-slave clock synchronization calibration, which can select the most accurate master clock, and precisely predict the amount of calibration required, thereby improving synchronization, stability, and accuracy.

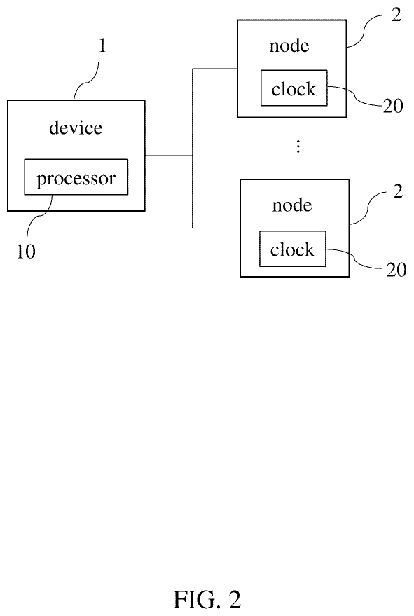

A method and device for master-slave clock synchronization calibration of the present embodiment can be applied to time calibration between nodes in network communications. Referring to FIG. 2, the technology of the present embodiment can be applied to time calibration for multiple nodes in the Internet. The Internet includes a master-slave clock synchronization calibration device 1 and multiple nodes 2. The device 1 is connected to multiple nodes 2. The device 1 includes a processor 10. Each node 2 includes a clock 20.

In this embodiment, the device 1 may be a network device such as a switch, router, or server, capable of executing the Precision Time Protocol (PTP). The processor 10 can be used to execute a computer program for the method for master-slave clock synchronization calibration, distributing the accurate time source to the nodes 2 in the Internet, ensuring that the time between multiple nodes 2 can be synchronized and aligned.

The node 2 can be a network computing device with timing and communication capabilities, such as routers, switches, servers, wireless access points, base stations, smart grid devices, and other devices. The clock 20 can be a hardware clock (Hardware Clock) or a real-time clock (Real-Time Clock, RTC), or any other timing module, chip, or device that provides the current time information. The processor 10 can receive the time information from the clock 20 provided by node 2 and, using the method for master-slave clock synchronization calibration, determine the most accurate clock 20 based on the received time information. The processor 10 will set the most accurate clock 20 as the master clock. Afterwards, the processor 10 will use the master clock to synchronize the time of other slave clocks. The specific process is as follows:

Before performing the calibration, the processor 10 first selects the most accurate clock 20 as the master clock. The method for selecting the master clock involves choosing the clock with a time variance that is the minimum, and the clock data provided by this clock will be used as the master clock data. In this embodiment, the processor 10 first filters out multiple clocks 20 that can provide more accurate time and calculates the variance of each of these clocks 20 based on the data they provide. The clock 20 with the smallest variance will be set as the master clock with the most accurate time.

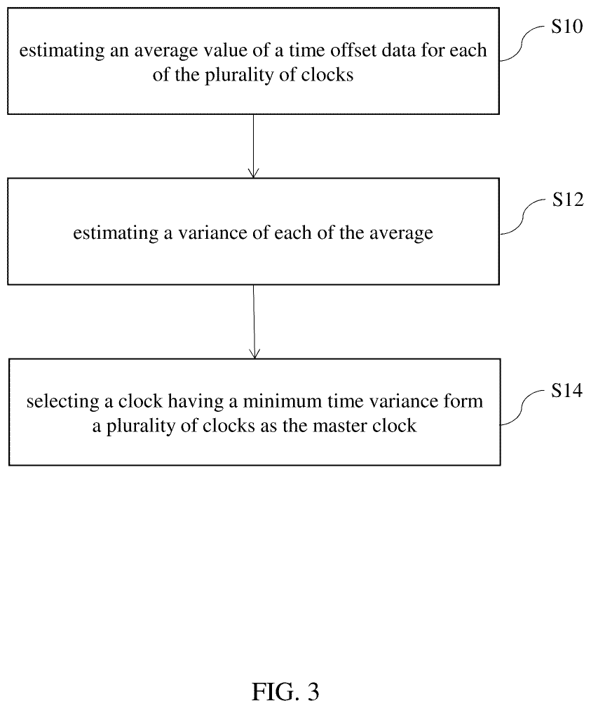

Please refer to FIG. 3 for the complete steps on how to calculate the minimum variance to select the master clock. As shown in step S10, the processor 10 receives time offset data Yᵢ from multiple time points of each clock 20 and calculates the average value Y of the time offset data Yᵢ for each clock 20. For example, if there are four clocks 20 selected as those providing accurate time, these four clocks 20 can each generate 300 pieces of time offset data Y₁, Y₂ . . . . Y₃₀₀ within a preset time period. The processor 10 will then calculate the average value Y of the 300 pieces of time offset data Y₁, Y₂ . . . . Y₃₀₀ for each clock 20. The average value Y can be calculated according to the following equation:

$$Y = \frac{( {Y}_{1} + {Y}_{2} + … + {Y}_{i} )}{i} ,$$

the Y is the average value, Yᵢ is the time offset data at different time points, and i is the number of time offset data points.

In step S12, the processor 10 estimates the variance S² of the average value Y calculated for each clock 20. The variance S² can be calculated using the following formula:

$${S}^{2} = \frac{1}{n} {\sum }_{i = 1}^{n} {( {Y}_{i} - Y )}^{2} ,$$

the n is the total number, Y is the average value, and Yᵢ is the time offset data at different time points.

In this embodiment, the variance S² is the time variance. After calculating the time variance S², step S14 is entered, where the processor 10 selects the clock 20 having a minimum time variance S² form a plurality of clocks as the master clock.

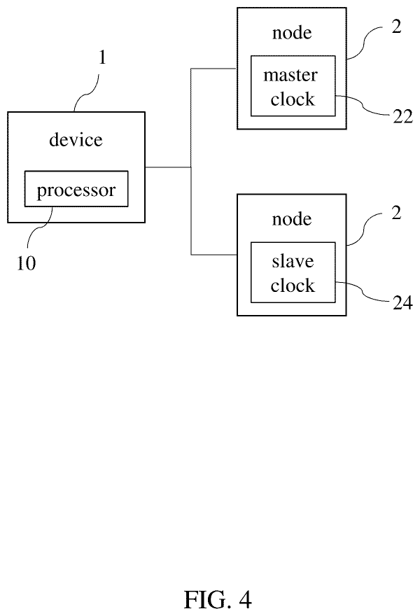

Refer to FIG. 4. FIG. 4 is a schematic diagram of a second embodiment of a device for master-slave clock synchronization calibration. To clarify the description, the names of the clocks are distinguished as the master clock 22 and the slave clock 24. The connections and operations of the device 1, processor 10, and node 2 are the same as those in the embodiment of FIG. 2, so they are not repeated. There can be multiple slave clocks 24, and the example shown in FIG. 4 is not limited to just one slave clock 24.

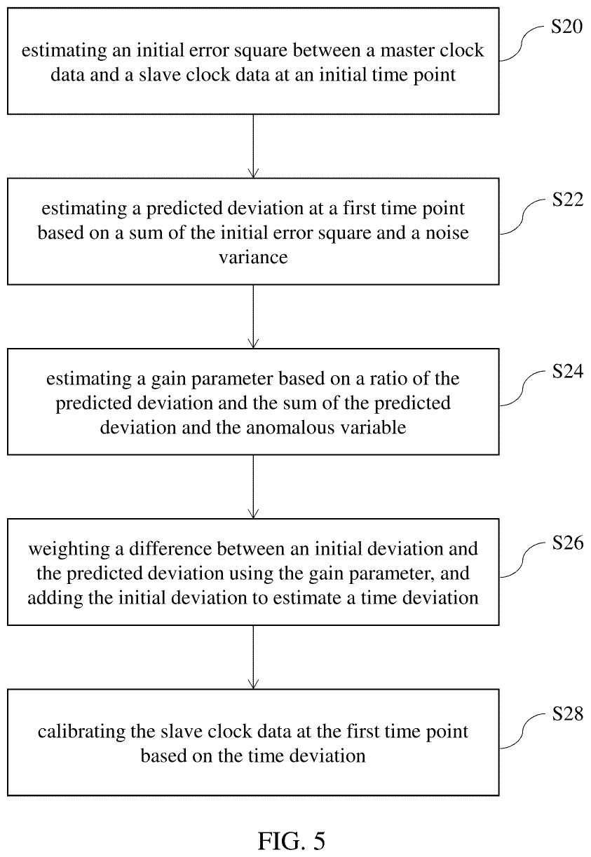

Refer to FIG. 4 and FIG. 5. After selecting the master clock 22 through steps S10~S14, proceed to steps S20~S28 to estimate the time deviation between the master clock 22 and the slave clock 24, in order to synchronize the time of the master clock 22 and the slave clock 24. As shown in step S20, the processor 10 estimates the initial error square P(T₀) at the initial time point T₀, which is the initial error between the master clock data and the slave clock data. The master clock data is the clock data generated by the master clock 22. The slave clock data is the clock data generated by the slave clocks 24 of other nodes 2. The processor 10 estimates the initial error square P(T₀) between the master clock data and the slave clock data using the following initial error square equation:

$${P ( {T}_{0} ) = ( estimated offset - measured offset )}^{2}$$

the P(T₀) is the initial error square, the estimated offset is the difference between the master clock data and the slave clock data based on estimation, and the measured offset is the difference between the master clock data and the slave clock data based on actual measurements.

For example, the processor 10 can estimate the difference between the master clock data and slave clock data at the initial time point T₀ using the open-source software Precision Time Protocol Daemon (PTPd) program, with the estimated difference being 15 ns. However, the actual measured difference between the master clock data and slave clock data, measured by an oscilloscope, is 12 ns. Therefore, the deviation between the two is 3 ns. In this embodiment, with a 10 ns scale conversion, the deviation becomes 3/10=0.3. Thus, the initial error square P(T₀) in this embodiment is calculated as follows:

$$P ( {T}_{0} ) = {( \frac{15 ns - 12 ns}{10} )}^{2} = 0.09 ◦$$

After estimating the initial error square P(T₀), the process moves to step S22. In step S22, the processor 10 estimates the predicted deviation Offset(T₁) at the first time point T₁, based on the sum of the initial error square P(T₀) and the noise variance Q. The noise variance Q takes into account factors such as potential inaccuracies in the processor 10 when running the program, instability in the synchronization signal from the synchronization source, or environmental factors such as temperature and humidity that may lead to signal errors. Therefore, noise is considered in this step. In this embodiment, the noise variance Q is not a fixed value and can be adjusted according to the requirements. A higher value for Q indicates more noise, while a value of Q equal to zero represents an ideal state with no noise.

The predicted deviation Offset(T₁) is estimated using the following predicted deviation equation:

$$Offset ( {T}_{1} ) = P ( {T}_{0} ) + Q ,$$

the Offset(T₁) is the predicted deviation, the P(T₀) is the initial error square, and the Q is the noise variance.

In step S24, the processor 10 estimates a gain parameter K based on a ratio of the predicted deviation Offset(T₁) and the sum of the predicted deviation Offset(T₁) and an anomalous variable R. In this embodiment, the anomalous variable R may represent the measurement error associated with the sample collection of the processor 10's chip.

The gain parameter is estimated using the following a gain parameter equation, as follows:

$$K = Offset ( {T}_{1} ) / [ Offset ( {T}_{1} ) + R ]$$

the K is the gain parameter, the Offset(T₁) is the predicted deviation, and the R is the anomalous variable.

Proceed to step S26, the processor 10 weights a difference between an initial deviation Offset(T₀) and the predicted deviation Offset(T₀) using the gain parameter K, and adding the initial deviation Offset(T₀) to estimate a time deviation X(T₁), a value of weighting is the gain parameter K, and the initial deviation Offset(T₀) is a deviation between the master clock data and the slave clock data at the initial time point T₁. The time deviation X(T₁) is estimated using the following a time deviation equation, as follows:

$$X ( {T}_{1} ) = Offset ( {T}_{0} ) + K * [ Offset ( {T}_{1} ) - Offset ( {T}_{0} ) ] ,$$

the X(T₁) is the time deviation, the Offset(T₀) is the initial deviation, the K is the gain parameter, and the Offset(T₁) is the predicted deviation.

Finally, proceed to step S28, the processor 10 calibrates the slave clock data at the first time point T₁ based on the time deviation X(T₁). Specifically, the processor 10 estimates the time deviation X(T₁), the deviation between the master clock 22 and the slave clock 24 at the first time point T₁ can be determined. Therefore, the time deviation X(T₁) can be directly used to calibrate the deviation in the slave clock 24's slave clock data.

In addition, the time deviation X(T₁) estimated by the processor 10 can also be applied to calibrate the offset value estimated by the Precision Time Protocol Daemon (PTPd) program.

In this embodiment, the processor 10 estimates the time deviation P_{Offset(T}_{₁}₎ of the slave clock 24 at the first time point T₁ through the PTPd program. The processor 10 estimates the time deviation X(T₁) of the slave clock 24 at the first time point T₁ through the method for master-slave clock synchronization calibration, it is used to calibrate the time deviation value P_{Offset(T}_{₁}₎ estimated by the PTPd program. The calibration equation is as follows:

$$Δ F = X ( {T}_{1} ) - {P}_{Offset ( {T}_{1} )} ,$$

the ΔF is the deviation adjustment magnitude, the X(T₁) is the time deviation calculated by the method for master-slave clock synchronization calibration, and the P_{Offset(T}_{₁}₎ is the time deviation calculated by the PTP algorithm.

When the time deviation X(T₁) is greater than the time deviation P_{Offset(T}_{₁}₎ calculated by PTP, the deviation adjustment magnitude ΔF is positive. When the time deviation X(T₁) is smaller than the time deviation P_{Offset(T}_{₁}₎ calculated by PTP, the deviation adjustment magnitude is negative. When the time deviation X(T₁) is equal to the time deviation P_{Offset(T}_{₁}₎ calculated by PTP, the deviation adjustment magnitude ΔF is zero.

For example, using the method in this embodiment, the time deviation X(T₁) at the first time point T₁ is estimated to be 22 ns, while the PTP time deviation P_{Offset(T}_{₁}₎ calculated by the PTPd program at the first time point T₁ is 25 ns. The processor 10 uses the calibration equation to calculate ΔF=22−25=−3 ns. This means that at the first time point T₁, the processor 10 needs to adjust the time deviation P_{Offset(T}_{₁}₎ estimated by the PTPd program downward by 3 ns to obtain a more accurate deviation value. By applying this adjustment method to the error estimated by the PTPd program, the slave clock 24 can become more synchronized with the master clock 22, improving the synchronization between the slave clock 24 and the master clock 22, and providing the slave clock 24 with better stability and precision.

As described above, the present invention can select the most accurate master clock and precisely predict the magnitude of the calibration needed for the slave clock, thereby improving the synchronization, stability, and precision of the slave clock.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method configured for master-slave clock synchronization calibration, the method comprising:
acquiring master clock data from a master clock and slave clock data from a slave clock;
estimating an initial error square between the master clock data and the slave clock data at an initial time point;
estimating a predicted deviation at a first time point based on a sum of the initial error square and a noise variance;
estimating a gain parameter based on a ratio of the predicted deviation and the sum of the predicted deviation and an anomalous variable;
weighting a difference between an initial deviation and the predicted deviation using the gain parameter, and adding the initial deviation to estimate a time deviation, wherein the initial deviation is a deviation between the master clock data and the slave clock data at the initial time point; and
calibrating the slave clock data of the slave clock at the first time point based on the time deviation.

2. The method of claim 1, further comprising: selecting a clock having a minimum time variance form a plurality of clocks as the master clock.

3. The method of claim 2, wherein the selecting a clock having a minimum time variance form a plurality of clocks as the master clock further comprises:
estimating an average value of a time offset data for each of the plurality of clocks; and
estimating a variance of each of the average values as the time variance.

4. The method of claim 1, wherein the initial error square is estimated using an initial error square equation:
$$P ( {T}_{0} ) = {( estimated offset - measured offset )}^{2} ,$$
where the P(T₀) is the initial error square, the estimated offset is an estimated difference between the master clock data and the slave clock data, and the measured offset is an actual measured difference between the master clock data and the slave clock data.

5. A device configured for master-slave clock synchronization calibration, the device comprising:
a processor configured to:
acquire a master clock data from a master clock and a slave clock data from a slave clock;
estimate the initial error square between the master clock data and the slave clock data at an initial time point;
estimate a predicted deviation at a first time point based on a sum of the initial error square and a noise variance;
estimate a gain parameter based on the ratio of the predicted deviation and the sum of the predicted deviation and an anomalous variable;
weight a difference between an initial deviation and the predicted deviation using the gain parameter, and adding the initial deviation to estimate a time deviation, wherein the initial deviation is a deviation between the master clock data and the slave clock data at the initial time point; and
calibrate the slave clock data of the slave clock at the first time point based on the time deviation.

6. The device of claim 5, wherein the processor further comprises: selecting a clock having a minimum time variance form a plurality of clocks as the master clock.

7. The device of claim 6, wherein the selecting a clock having a minimum time variance form a plurality of clocks as the master clock further comprises:
estimating an average value of a time offset data for each of the plurality of clocks; and
estimating a variance of each of the average values as the time variance.

8. The device of claim 5, wherein the initial error square is estimated using the following an initial error square equation, as follows:
$$P ( {T}_{0} ) = {( estimated offset - measured offset )}^{2} ,$$
where the P(T₀) is the initial error square, the estimated offset is an estimated difference between the master clock data and the slave clock data, and the measured offset is the an actual measured difference between the master clock data and the slave clock data.

9. A method configured for master-slave clock synchronization calibration, the method comprising:
selecting a clock having a minimum time variance form a plurality of clocks;
acquiring master clock data from a master clock and slave clock data from a slave clock;
estimating an initial error square between the master clock data and the slave clock data at an initial time point;
estimating a predicted deviation at a first time point based on a sum of the initial error square and a noise variance;
estimating a gain parameter based on the ratio of the predicted deviation and the sum of the predicted deviation and an anomalous variable;
weighting a difference between an initial deviation and the predicted deviation using the gain parameter, and adding the initial deviation to estimate a time deviation, wherein the initial deviation is a deviation between the master clock data and the slave clock data at the initial time point; and
calibrating the slave clock data of the slave clock at the first time point based on the time deviation.

10. The method of claim 9, wherein the selecting a clock having a minimum time variance form a plurality of clocks as the master clock further comprises:
estimating an average value of a time offset data for each of the plurality of clocks; and
estimating a variance of each of the average values as the time variance.

11. The method of claim 9, wherein the initial error square is estimated using the following an initial error square equation, as follows:
$$P ( {T}_{0} ) = {( estimated offset - measured offset )}^{2} ,$$
where the P(T₀) is the initial error square, the estimated offset is an estimated difference between the master clock data and the slave clock data, and the measured offset is an actual measured difference between the master clock data and the slave clock data.
